(19) United States
(12) Patent Application Publication
(10) Pub. No.: US 2007/0097867 A1
(43) Pub. Date: May 3, 2007

(54) Techniques to provide a new or suggested data transmission schedule in a wireless network

(76) Inventors: Jarkko Lauri Sakari Kneckt, Espoo (FI); Jari Jokela, Ylojarvi (FI); Mika Kasslin, Espoo (FI)

Correspondence Address: Brake Hughes PLC;c/o PortfolioIP, P.O. Box 52050, Minneapolis, MN, 55402, US

(21) Appl. No.: 11/266,775

(22) Filed: Nov. 3, 2005

(51) Int. Cl. H04L 12/26; H04Q 7/00

(52) U.S. Cl. 370/236; 370/329

(57) ABSTRACT

Various embodiments are disclosed relating to techniques to provide a new or suggested data transmission schedule in a wireless network. According to an example embodiment, an AP may provide a station with a new (or changed) data transmission schedule or a suggested data transmission schedule to relocate the data transmission or contention start times for stations to a more favorable time (e.g., where there may be a lower probability for collisions with other stations).

### BACKGROUND

The rapid diffusion of Wireless Local Area Network (WLAN) access and the increasing demand for WLAN coverage is driving the installation of a very large number of Access Points (AP). However, most wireless networks today offer little or no Quality of Service (QoS). While QoS may refer to many different concepts, QoS may, for example, include providing different levels or qualities of service for different types (or classes) of traffic. A draft specification from the Institute of Electrical and Electronics (IEEE) 802.11e Task Group has proposed a set of QoS parameters to be used for traffic delivery between an Access Point (AP) and a station in a wireless network.

According to the 802.11e draft specification, Enhanced Distributed Channel Access (EDCA), for example, provides a contention based channel access mechanism that differentiates between different traffic classes (Access Categories or AC). According to EDCA, a different set of parameters (such as a contention window size or CW and a minimum period of time to sense an idle medium before transmitting) may be provided for each AC. By using a different set of access and contention parameters for each access category (AC), this may change the probability of obtaining or contending for access to the channel to favor higher priority ACs (traffic classes).

The IEEE 802.11e draft specification also allows for power management through automatic power-save delivery (APSD). APSD provides two delivery mechanisms: scheduled APSD and unscheduled APSD. Stations may use unscheduled APSD (U-APSD) to have all or some of their frames delivered to them from the AP during unscheduled service periods. An unscheduled service period may begin when the AP receives a trigger message from the station. According to scheduled APSD (S-APSD), a station may receive a data transmission schedule from an AP indicating a service start time and service interval when the station may receive and transmit frames during scheduled service periods. For example, by using APSD, a station may conserve power and extend battery life by remaining in a lower power state, and then waking during a scheduled or unscheduled service period to receive and transmit data.

However, a problem may arise in some cases if multiple high AC streams (e.g., AC3) are transmitting or attempting to transmit on the medium at about the same time, since these streams may typically use the same set of EDCA parameters for channel access and contention. Because such high AC streams, for example, may be using the same EDCA parameters, this may increase the likelihood that such high AC streams will collide or interfere with each other, sometimes repeatedly. In addition, no mechanism is currently available to allow a station to indicate that a problem exists with its transmission schedule.

### SUMMARY

Various embodiments are disclosed relating to a technique to provide a new or suggested data transmission schedule in a wireless network.

According to an example embodiment, a first wireless station in a wireless network may receive a first data transmission schedule from a second wireless station (such as an access point or AP). The first wireless station may attempt to transmit data according to the first data transmission schedule. The first station may transmit a request for a data transmission schedule change (or a new schedule) to the second wireless station. The first station, for example, may transmit this request for a new schedule if the first station encountered significant interference or collisions on the channel while transmitting during the scheduled service periods for the first schedule. The first wireless station may then receive a second data transmission schedule from the second wireless station (AP). In this manner, a station may request and obtain from an AP a new schedule or schedule change as necessary and/or to allow an AP to move or relocate a scheduled service period for a station to a location or time that may provide less interference for the station.

According to another example embodiment, a first wireless station may transmit a request for a suggested data transmission schedule to a second wireless station (e.g., AP). The first wireless station may receive from the second wireless station (AP) the suggested data transmission schedule. According to an example embodiment, a station operating in full power mode (or non power-save mode) or unscheduled automatic power-save delivery (U-APSD) mode, or other non-scheduled mode may request a suggested schedule and then may optionally transmit and receive data or contend for channel access during times indicated by the suggested schedule. Thus, in this example embodiment, although such a suggested data transmission schedule may not be mandatory for such a station, the suggested schedule may provide the station with a helpful hint or recommendation by an AP for a time to transmit data or contend for a transmission opportunity (TXOP) when the channel may less occupied or provide a lower probability for interference from other stations, for example.

According to another embodiment, an apparatus may be provided in a wireless station. The apparatus may include, for example, a controller, a memory coupled to the controller, and a wireless transceiver. The apparatus may be adapted to transmit a request for a suggested data transmission schedule to a first wireless station, and then receive, in response to the request, a suggested and optional data transmission schedule from the first wireless station.

According to yet another example embodiment, a first station may receive a measurement report including information relating to a performance of a second wireless station. The first station may transmit a data transmission schedule to the second station. According to an example embodiment, the measurement report may be a quality of service (QoS) related report including one or more measured QoS parameters or metrics for the second station. In yet another embodiment, the measurement report may be a triggered QoS related report that may be transmitted to the first station, for example, when one or more QoS metrics or parameters for the second station reaches a trigger threshold.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a diagram illustrating operation of a contention based channel access by multiple stations.

FIG. 3 is a flow chart illustrating operation of wireless station according to an example embodiment.

FIG. 4 is a flow chart illustrating operation of wireless station according to another example embodiment.

FIG. 5 is a diagram illustrating operation of a wireless station and AP according to an example embodiment.

FIG. 6 is a diagram illustrating a format of an Add traffic stream request frame according to an example embodiment.

FIG. 7 is a diagram illustrating a format of a frame body for an Add traffic stream response according to an example embodiment.

FIG. 8 is a flow chart illustrating operation of a wireless station according to another example embodiment.

FIG. 9 is a diagram illustrating operation of a wireless station and AP according to yet another example embodiment.

FIG. 10 is a diagram illustrating a schedule frame body according to an example embodiment.

FIG. 11 is a block diagram illustrating an apparatus provided in a wireless station according to an example embodiment.

### DETAILED DESCRIPTION

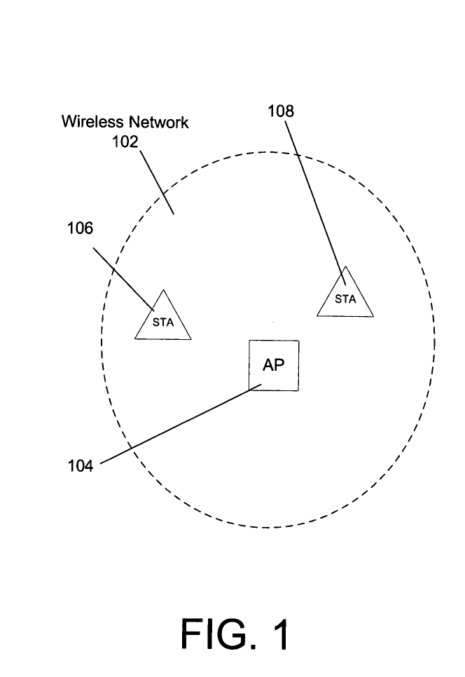

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station and one or more mobile stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), cellular networks, radio networks, or other wireless networks. In another example embodiment, the various examples and embodiments may be applied to a meshed wireless network, where a plurality of mesh points (e.g., Access Points) may be coupled together via wired links.

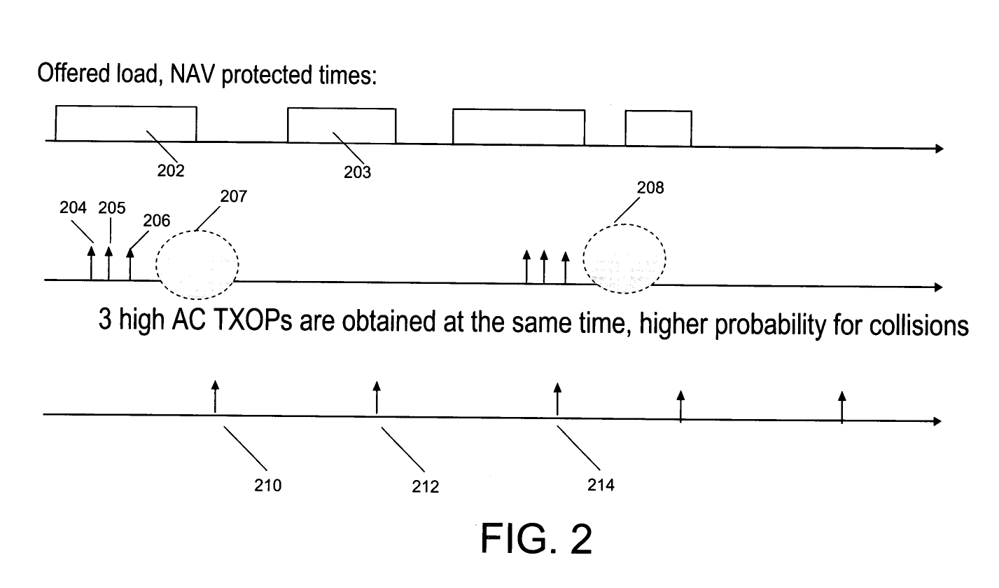

FIG. 2 is a diagram illustrating operation of contention based channel access by multiple stations. Several network allocation vector (NAV) protected times (e.g., contention free periods when the channel is not available) are shown, including periods 202, 203, etc. In this example multiple stations are ready to transmit frames at times shown as 204, 205 and 206. Each station may typically sense the medium at the end of the NAV protected time and may begin to transmit if the medium or channel is idle for an AIFS[AC] (arbitration inter frame space[AC] period of time. According to EDCA, the wait period AIFS[AC] may be different for each access category (AC) (e.g., shorter AIFS for higher ACs) to favor higher ACs.

However, a problem may arise in some cases if multiple high AC streams (e.g., AC3), such as multiple voice over IP (VoIP) streams, are transmitting on the medium, since these streams will typically use the same set of EDCA parameters for channel access and contention (such as CW[AC], AIFS[AC], etc.). Thus, in this example, multiple stations each transmitting a high AC (AC3) stream may transmit after waiting a same period of time, such as AIFS[AC3]. In some cases, this may result in a collision at 207 (FIG. 2).

Also, in the event of a collision or an occupied medium or channel when sensed, each of the stations (being the same access category), may also use a same backoff procedure and same EDCA parameters (CW, AIFS, etc.), resulting in a significant possibility of a subsequent collision, such as at 208. For example, if contention starts when medium is occupied by another transmission, then a station may typically defer for a time determined by a backoff timer. Backoff time may be randomly selected between [0, CW[AC]], where CW depends on the AC and the number of retransmissions. In the case of highest AC (AC3), CWmin=1 time slot, and CWmax=3, in an example embodiment. After a successful transmission, CW=CWmin and backoff timer may be either 0 or 1, for example. If there are multiple stations transmitting AC3 traffic (frames) and starting contention during an occupied period, all of these stations may defer their transmissions according to the same rules. For example, approximately half may transmit at about the same time, which may result in collisions and wasted resources. An example collision from this type of situation may be shown as 207 and 208 in FIG. 2, for example.

In addition, some types of applications, such as VoIP, may generate frames for transmission at regular intervals (e.g., every 20 ms), which may further increase the probability for a subsequent collision with similar high AC data streams (e.g., other VoIP streams). This situation, if it occurs, may result in delay and unnecessary power consumption due to the collisions and backoff. One or more aspects or embodiments described herein may be applied to a variety of different types of traffic, such as VoIP, video, streaming video, other streaming applications, and traffic from other applications. Some of these applications may generate or process data for transmission on a periodic or almost periodic basis, and this information may be used by an AP in providing schedules or suggested schedules to stations. In addition, the AP may also be able to provide schedules for lower AC traffic that may better avoid data contention with higher AC traffic (e.g., allocating lower AC traffic to times where higher AC sources are not transmitting or contending for TXOPs). These are merely a few example situations that may arise in some cases, and the various embodiments described herein are not limited to addressing these situations.

According to an example embodiment, an AP may provide a station with a new (or changed) data transmission schedule or a suggested data transmission schedule to relocate the data transmission or contention start times for stations to times where there may be a lower probability for collisions with other stations. Thus, in an example embodiment, an AP may provide changed (updated) or suggested data transmission schedules to one or more stations in order to relocate the data transmission or contention start times for one or more traffic streams (e.g., that previously may have collided at 207) to new data transmission times (or contention start times), shown as times 210, 212 and 214. This may allow an AP to randomize contention start times for various stations or to select or relocate contention start times (or data transmission periods) for a station, as needed or upon request, to a time or location where the channel or medium may be more favorable (e.g., less occupied or less busy.

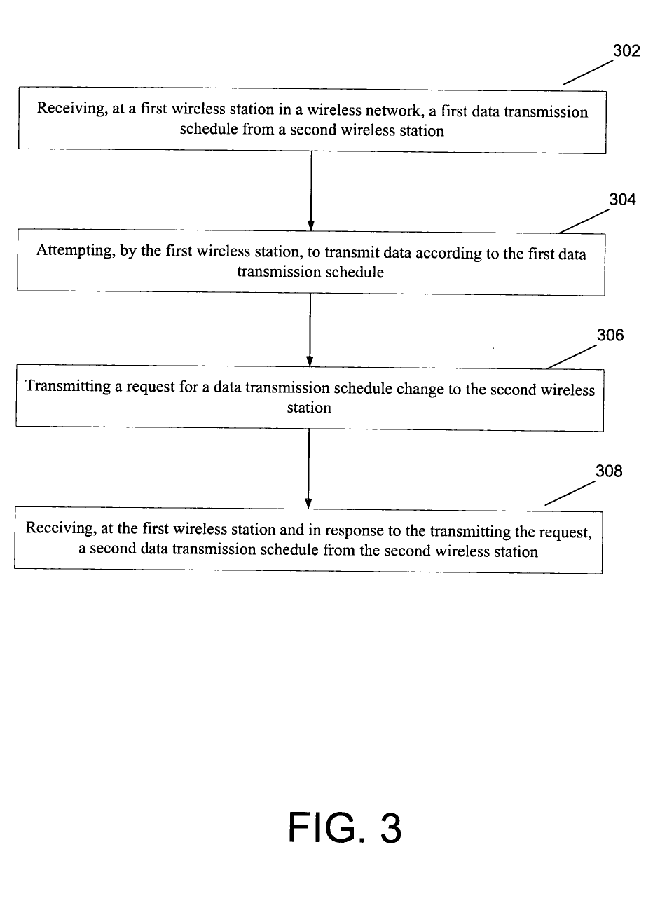

FIG. 3 is a flow chart illustrating operation of wireless station according to an example embodiment. At 302, a first wireless station in a wireless network may receive a first data transmission schedule from a second wireless station (e.g., an AP). The data transmission schedule may identify a contention start time or a data transmission start time (or period), for example, for the first wireless station. Although not required, the first data transmission schedule may be received by the first station in response to a request, such as an Add Traffic Stream (AddTS) request, for example. The first data transmission schedule may be received by the first station via a number of different frames or messages, such as an Add Traffic Stream (AddTS) response or a Schedule frame, for example. The first data transmission schedule may be sent from AP 104 to a station 106, for example (FIG. 1).

At 304, the first wireless station may attempt (e.g., via contention based channel access) to transmit data according to the first schedule. This may involve, for example, the first station contending for a TXOP or transmitting data during a time period indicated by the first data transmission schedule.

In an example case, the first wireless station may, depending on the situation, encounter significant collisions or other interference or transmission difficulty when attempting to transmit data or contending for transmission opportunities (TXOPs) at the scheduled times. Therefore, due to such problems (e.g., interference with other stations) with the first data transmission schedule for the first wireless station, at 306, may transmit a request to the second station for a data transmission schedule change (or request for a new schedule) to the second wireless station. The station may request a new schedule for other reasons as well, and this is merely one example.

The first wireless station may also include a requested new schedule in the request for a data transmission schedule change, 306. However, the AP may or may not approve or grant the requested schedule. Also, the AP (second wireless station in this example), at least in some cases, may be more likely to have greater or more accurate information describing the number of active stations, traffic streams and access categories (ACs) of each stream, the transmission times or schedules of each traffic stream or station, etc. for the other traffic in the network. Therefore, the AP may be in a better position to identify a new (e.g., better) schedule or schedule change for the first wireless station, e.g., a identify a time or location where the channel may be less occupied or less likely to encounter interference with other stations, etc.

Therefore, at 308, the first wireless station may receive from the second wireless station a second data transmission schedule (or a schedule change). The first wireless station may then attempt to transmit data according to the second wireless station. This process may, in some cases, be repeated as necessary, with the first station submitting requests to the second station (e.g., AP) for a new or changed schedule if a specific level of performance or QoS is not obtained by the first station, for example.

In an example embodiment, the first wireless station may be operating in a scheduled power-save delivery mode (such as S-APSD). In this case, the first wireless station, operating in S-APSD mode for example, may wake at the scheduled time to receive frames and/or contend for TXOPs or transmit data. If, for example, the station encounters collisions or other difficulties in transmitting data, the first station may again request a new or changed data transmission schedule.

In an alternative embodiment, a data transmission schedule request and schedule response may be forwarded via one or more intermediate APs, routers or other stations. For example, at 302, a first wireless station may receive a first data transmission schedule from a third wireless station via a second (or intermediate) wireless station. At 306, the first station may transmit a request for a data transmission schedule to the second wireless station. The second wireless station may then forward the request for a new data transmission schedule to a third wireless station. At 308, according to this example embodiment, the third wireless station may, in response to the request, transmit a second data transmission schedule to the second wireless station, which may then forward this response (providing the requested second data transmission schedule) to the first wireless station.

Such an arrangement of transmitting requests for data transmission schedules and receiving data transmission schedules via one or more intermediate APs or other stations may be useful, for example, in a Mesh network where multiple APs may be coupled together via wired or other links, or for an extended service set (ESS), which may be implemented, for example, in a WLAN network based on one or more of the Institute of Electrical and Electronics Engineers (IEEE) 802.11 family of industry specifications, such as specifications for IEEE 802.11b, IEEE 802.11g and IEEE 802.11a, etc. A group of 802.11 mobile stations may communicate with each other (either directly or through one AP) in a network known as a basic service set (BSS), which may be identified by a basic service set identifier (BSSID). A group of BSSs (e.g., with one AP per BSS) may be coupled together in a larger WLAN network (e.g., with multiple APs) known as an extended service set (ESS), which may be identified by a service set ID (SSID). These are merely some examples and the disclosure is not limited thereto. The use of an intermediate station or AP to forward schedule requests and responses may be used for many different networks or technologies.

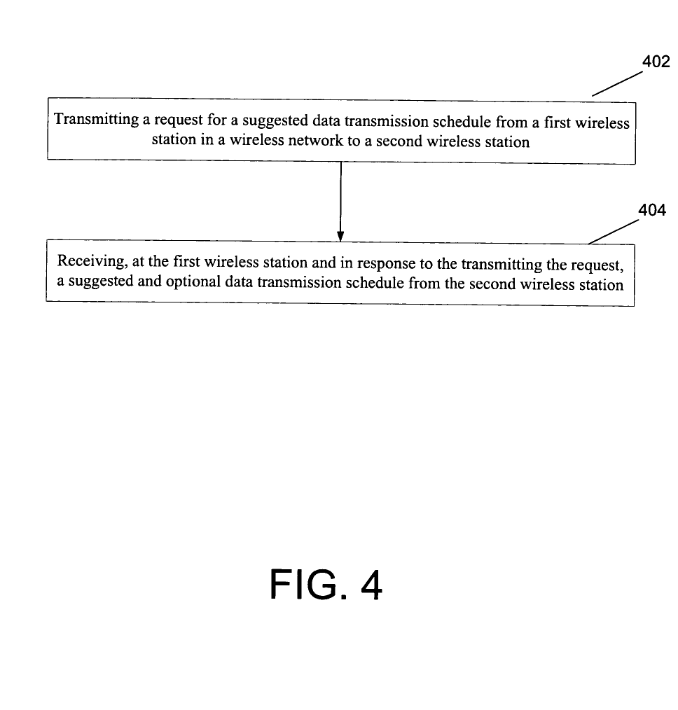

FIG. 4 is a flow chart illustrating operation of wireless station according to another example embodiment. At 402, a first station may transmit a request for a suggested data transmission schedule to a second wireless station (e.g., AP). This request may be transmitted to the second station (AP) via a number of different types of messages or frames, such as an Add Traffic Stream (AddTS) request, for example. At 404, the first station may receive, in response to transmitting the request, a suggested or optional data transmission schedule from the second wireless station (e.g., AP). This schedule may be provided via a number of different types of messages, such as an Add Traffic Stream (AddTS) response, for example.

In an example embodiment with respect to the flow chart of FIG. 4, the first wireless station may be operating in either an U-APSD mode or a non power-save (or full power) mode, or other non-scheduled mode. In this example embodiment, because the first station may not be using a schedule mode, such as S-APSD, the schedule that may be provided by the AP to the first station may be considered a suggested and optional data transmission schedule (e.g., not mandatory). Thus, in this case, the first station may transmit and receive frames according to the suggested schedule, or may transmit and receive data frames outside of the suggested schedule. The use of a suggested schedule may be used for stations operating in a variety of different modes, including in some cases stations operating in scheduled modes.

According to an alternative embodiment, at 402, the request for a suggested data transmission schedule may be forwarded to a second wireless station via one or more intermediate APs, routers, or other stations (similar to that described above for FIG. 3). Likewise, at 404, the response providing the suggested data transmission schedule to the first station may be transmitted from the second station to the first station via one or more intermediate APs, routers or other stations.

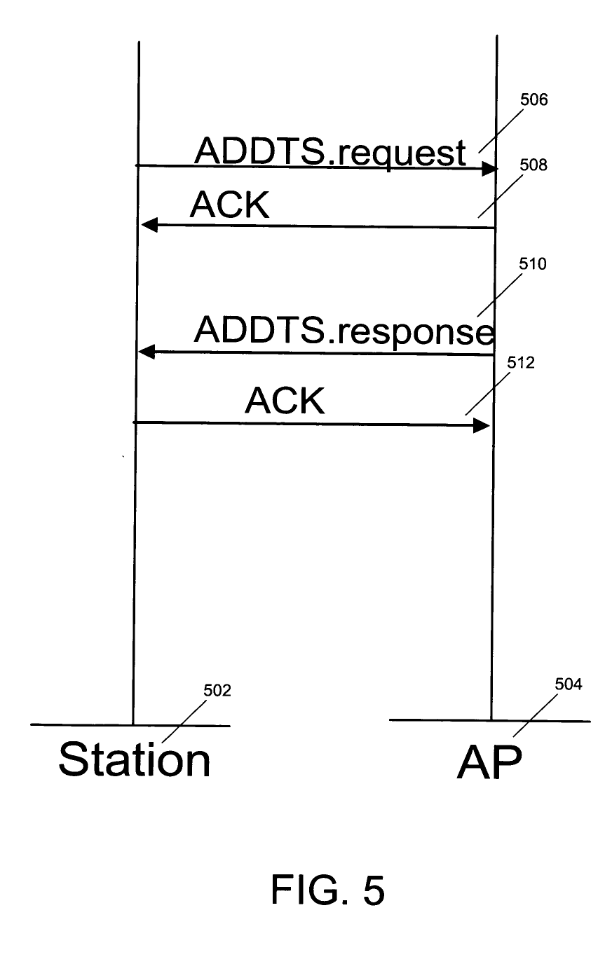

FIG. 5 is a diagram illustrating operation of a wireless station and AP according to an example embodiment. In the example shown in FIG. 5, a wireless station 502 may be in wireless communication with an AP (access point) 504. Station 502 may be operating in either a U-APSD mode, a S-APSD mode, or a non power-save mode, as examples, or other mode. Station 502 may send AP 504 an Add traffic stream (AddTS) request (AddTS.Request) 506 requesting a new or changed schedule (e.g., for a S-APSD mode station) or requesting a suggested schedule (e.g., for station operating in U-APSD mode, a non power-save mode or other non-scheduled mode). AP 504 may provide an acknowledgement (Ack) 508 to station 502. AP 504 may then provide the requested data transmission schedule via an Add traffic stream (AddTS) response (AddTS.Response) 510. The station 502 may then provide an acknowledgement 512 to AP 504.

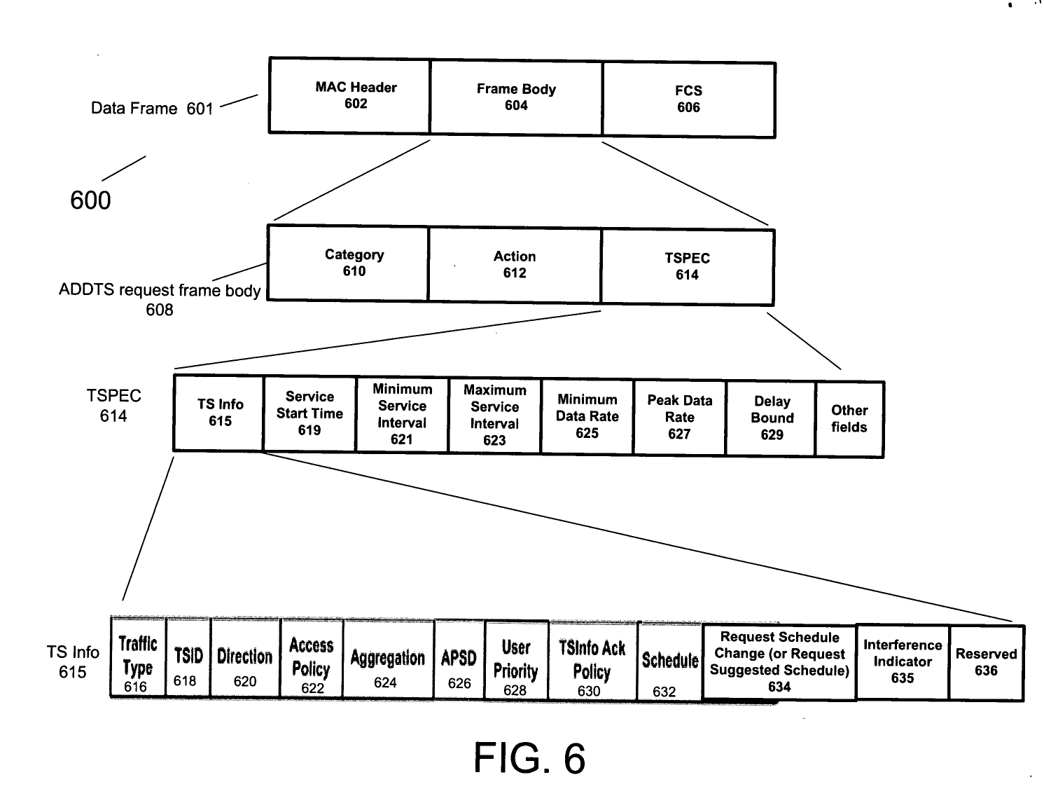

FIG. 6 is a diagram illustrating a format of an Add traffic stream request frame according to an example embodiment. AddTS request frame 600 may include a MAC header 602 that may include address and other information, a frame body 604 and a frame check sequence (FCS) 606. In an example embodiment, frame body 604 for AddTS request 600 may be an AddTS request frame body 608. The AddTS request frame body 608 may include a category field 610 set to a value indicating QoS (e.g., QoS related frame). An action field 612 may be set to a value indicating AddTS request.

AddTS request frame body 608 may also include a traffic specification or TSPEC 614. TSPEC 614 may include, for example, one or more parameters or values that may describe QoS characteristics of a data flow or traffic stream (or requested traffic stream) to and/or from a station, as well as other information. Some of the example fields that may be provided in an example TSPEC are shown as TSPEC 614 in FIG. 6.

TSPEC 614 may include, for example, a TS Info field 615, which is described in further detail below. TSPEC 615 may also include one or more parameters that may, for example, describe a requested schedule, such as a service start time 619, a minimum service interval 621 and a maximum service interval 623. (According to an example embodiment, the AP may accept or reject the requested schedule). TSPEC 614 may also include values that may describe QoS characteristics of a data flow or traffic stream (or requested traffic stream), such as minimum data rate 625, peak data rate 627, delay bound 629, etc. TSPEC 614 may include other fields.

Referring to a lower portion of FIG. 6, the TS Info field 615 of the TSPEC 614 may include a traffic type 616 which may, for example, indicate a periodic traffic pattern or may indicate an aperiodic or unspecified traffic pattern or other traffic type. A TSID 618 provides a traffic stream ID (identifier), and a direction 620 identifies the direction for the traffic stream (e.g., AP to station, station to AP, station to station, and bidirectional). Access policy 622 may identify the access policy for the traffic stream (e.g., contention-based channel access or EDCA, controlled channel access or HCCA, or mixed, or other policy). Aggregation 624 may be set to 1 to indicate that an aggregate schedule for a station (e.g., indicating an aggregate schedule for multiple or all traffic streams for a station) is being requested (by a station) or set to 1 by an AP when an aggregate schedule is being provided by an AP.

APSD 626 may be set to 1 to indicate that automatic power-save delivery (either U-APSD or S-APSD) to be used for traffic associated with the TSPEC, and may be set to 0 otherwise. User priority 628 may indicate the user priority for frames of this traffic stream (e.g., 8 user priorities may map to 4 access categories). TSInfo Ack Policy 630 may indicate an acknowledgement policy to be used (e.g., no acknowledgement, single frame acknowledgement, block acknowledgement). Schedule 632 may indicate whether a schedule is being used or requested for this traffic stream. When the APSD 626 is set to indicate automatic power-save delivery mode, then schedule 632 may be set to 0 to indicate U-APSD and set to 1 to indicate S-APSD, for example.

A request schedule change (or request suggested schedule) flag 634 may be set to allow a station to request a new or changed data transmission schedule (e.g., for stations operating in S-APSD mode). Flag 634 may also be set to 1 to allow a station to request a suggested or optional data transmission schedule, e.g., for stations not operating in S-APSD mode, such as stations operating in U-APSD mode or a non power-save (or full power) mode, or other non-scheduled mode, for example, although the use of a requested schedule is not limited to these example modes. Field 636 may be reserved.

According to an example embodiment, TS Info field 615 may include an interference indicator field 635 that may allow a station to indicate that interference (e.g., collisions, signal distortion and/or other interference) may have been detected or encountered by the transmitting station. The detected interference may include, for example, data collisions with other wireless stations transmitting at about the same time, radio interference with other types of radios transmitting at about the same time as the WLAN station (e.g., the station's own Bluetooth transmitter, cellular or GSM radio, and the like, or other radio transmission from another station), or other radio interference. In an example embodiment, if the station is transmitting or contending for TXOPs according to a data transmission schedule (e.g., at scheduled times or based on S-APSD), the interference indicator field 635 may indicate that the station encountered collisions, distortion or other interference during the scheduled transmission time (e.g., the station's current schedule is not favorable and should be moved to another time/location).

In another example embodiment, e.g., if a station is operating in either a non power-save delivery mode or an unscheduled power-save delivery mode (e.g., U-APSD), the station may set the interference indicator 635 to indicate that interference may have been detected by the station at a particular time. In an example embodiment, the service start time 619 may identify when the interference was first detected (e.g., a first interference period), the minimum service interval 621 may indicate the time interval between two interference periods, and the maximum service interval 623 may indicate a duration of the detected interference periods (or average duration), etc. However, this is merely an example, and many other techniques or fields may be used to indicate to the AP the period of time where interference was detected. Therefore, the interference indicator field 635 may allow a station to indicate to an AP an undesirable (or unsuitable) schedule (e.g., which should be avoided by the AP when the AP may provide a new or suggested schedule in reply to the ADDTS request message, such as in a ADDTS response)

In an alternative embodiment, an AP may send a message to a station (e.g., such as an ADDTS response message) indicating that a specific period of time or specific schedule may be not recommended or unsuitable, or interference detected at this time. An AP may, for example, may set the interference indicator 635 (e.g., in an ADDTS response or other message to a station) to indicate that interference may have been detected by the AP at a particular time. In an example embodiment, the service start time 619 may identify when the interference was first detected (e.g., a first interference period), the minimum service interval 621 may indicate the time interval between two interference periods, and the maximum service interval 623 may indicate a duration of the detected interference periods (or average duration), etc. This may provide a mechanism to allow an AP to identify to a station a busy or unsuitable (or not recommended) time for data transmission, for example. Many other techniques may be used.

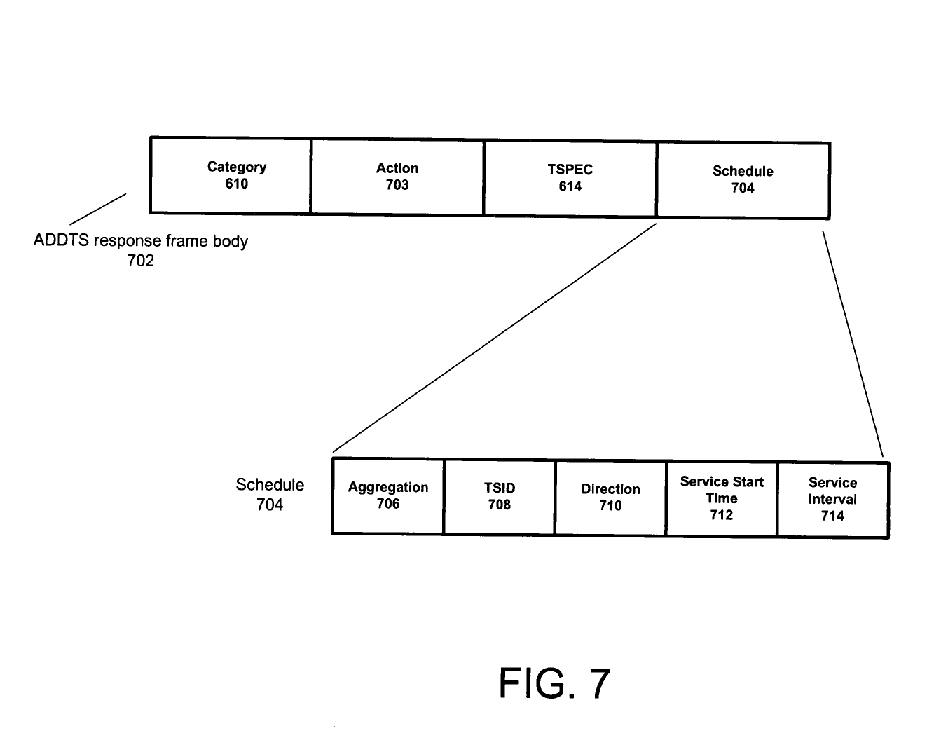

FIG. 7 is a diagram illustrating a format of a frame body for an Add traffic stream (AddTS) response according to an example embodiment. AddTS response frame body 702 may be provided as the frame body within data frame 601 (FIG. 6), for example. AddTS response frame body 702 may include a number of fields, such as a category 610 (e.g., indicating QoS), action 703 (e.g., indicating AddTS response), a TSPEC 614 (see FIG. 6), and a data transmission schedule 704.

Schedule 704 may include a number of fields, some of which may be shown in FIG. 7. Schedule 704 may include additional fields not shown, and may be provided in a number of different formats. Aggregation field 706 may be set to 1 if the provided data transmission schedule is an aggregate schedule for all TSID associated with the station to which the AddTS response is directed, for example. TSID 708 may provide a traffic stream ID, and direction 710 identifies the direction for the traffic stream. Service start time 712 may indicate the anticipated start time or the beginning of the first (scheduled) service period. Service interval 714 indicates the time between two successive service periods (e.g., period between start times for two successive service periods). This is merely one example and other fields may be used to provide a data transmission schedule.

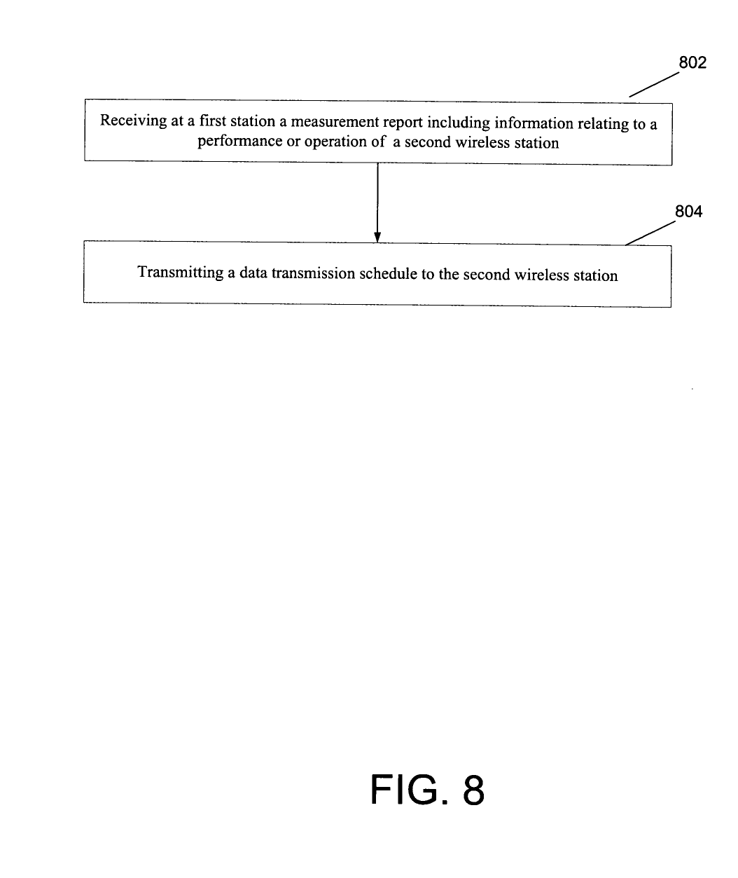

FIG. 8 is a flow chart illustrating operation of wireless station according to another example embodiment. At 802, a first station may receive a measurement report including information relating to a performance or operation of a second wireless station. At 804, for example, in response to the measurement report, the first station may send the second station a data transmission schedule. According to an example embodiment, this may allow an AP to receive performance or QoS related information or other report for a station, for example, and then to send the station a new data transmission schedule (or suggested schedule) to relocate the data transmission time or data contention time for the station (via a new schedule). The AP may send a new schedule or suggested schedule to the station, for example, if the report for the station indicates that such a schedule relocation would be desirable, e.g., if the report indicates a relatively low QoS for the station (e.g., below a threshold QoS). Thus, the example embodiment described in the flow chart of FIG. 8 may allow an AP to initiate a relocation of a scheduled service period (e.g., scheduled time for contention or data transmission) for a station based on a measurement report or other information describing a QoS delivered to the station or performance of the station, etc.

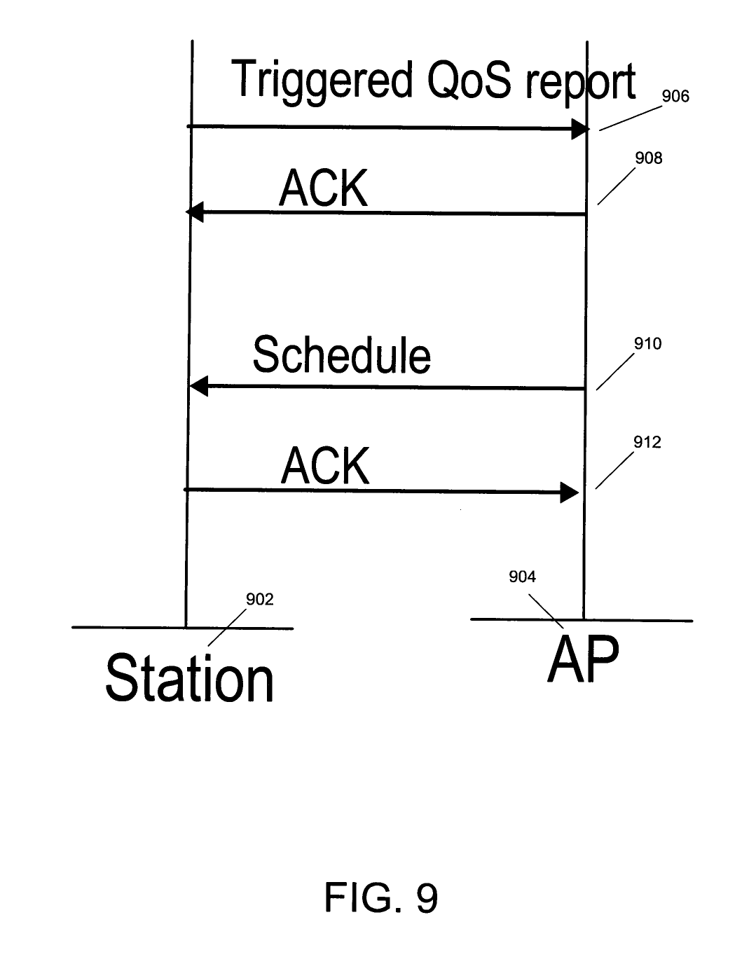

FIG. 9 is a diagram illustrating operation of a wireless station and AP according to an example embodiment. A station 902 and an AP 904 may be in wireless communication. At 906, station 902 may transmit a triggered QoS measurement report to AP 904. At 908. AP may transmit an acknowledgement to station 902. At 910, in response to the triggered QoS measurement report, AP 904 may transmit a data transmission schedule to station 902. The data transmission schedule (e.g., schedule 704) may be transmitted via a variety of messages, such as a schedule frame, or an AddTS response frame, as examples. At 912, station 902 may then transmit an acknowledgement to AP 904.

According to an example embodiment, AP 904 and station 902 may have previously negotiated or agreed (e.g., based on a request from AP 904) that station 902 would send AP 904 a QoS measurement report describing a QoS delivered to the station 902 or the performance of the station 902, for example, e.g., relating to one or more QoS parameters or QoS metrics. The transmission of this report (from station 902 to AP 904) may be triggered, for example, when one or more QoS parameters or QoS metrics for station 902 reaches a predetermined threshold. The AP 904 may specify one or more trigger thresholds for these measured QoS metrics or parameters that may trigger station 902 to send the triggered QoS measurement report to AP 904. For example, the station 902 may monitor one or more QoS parameters or metrics for itself, such as a number or percentage of failed frames, a number or percentage of discarded frames, a number or percentage of multiple retries, an average queue delay, average transmit delay, etc. The QoS measurement report may be automatically generated and transmitted by station 902 to AP 904 when one or more of these QoS metrics reach a trigger threshold, for example. The QoS measurement report may, for example, report or provide information relating to any of these QoS metrics for station 902 or other information, or may simply indicate that a specific QoS parameter has reached a predetermined threshold (e.g., average queue delay for the station has exceeded 10 ms).

For example, at 910, the AP 904 may determine if the received measurement report indicates the performance or operation of the wireless station 902 meets a condition or criteria. The AP 904 may, for example, then transmit a (e.g., changed or new or suggested) data transmission schedule to the station 902 if, based on the measurement report, the performance or operation of the wireless station 902 meets the criteria (e.g., average queue delay for the station exceeds 10 ms or meets other criteria). The criteria may, for example, be a condition or criteria relating to QoS or station performance (such as the station's average queue delay in this example). A wide variety of conditions or criteria may be used to cause the AP 904 to transmit a new or changed (or suggested) schedule to the station 902.

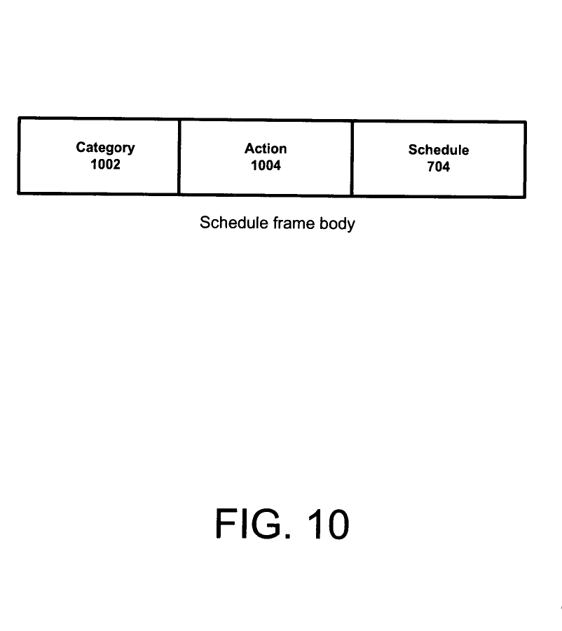

According to an example embodiment, an AP may use a schedule frame to send a schedule to a station whenever the AP changes the station's schedule. FIG. 10 is a diagram illustrating a schedule frame body according to an example embodiment. The schedule frame body may include a category field 1002 (e.g., indicating QoS), an action field 1004 (e.g., indicating schedule frame) and a schedule 704 (see FIG. 7).

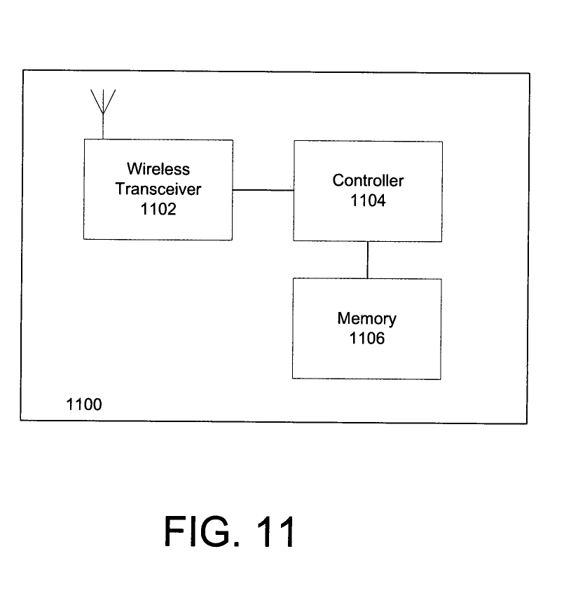

FIG. 11 is a block diagram illustrating an apparatus 1100 that may be provided in a wireless station according to an example embodiment. The wireless station may include, for example, a wireless transceiver 1102 to transmit and receive signals, a controller 1104 to control operation of the station and execute instructions or software, and a memory 1106 to store data and/or instructions. Controller 1104 may be programmable, and capable of executing software or other instructions stored in memory or on other computer media to perform the various tasks and functions described above. For example, controller 1104 may be programmed to transmit a request for a suggested data transmission schedule to an AP, and then receive, in response to transmitting the request, a suggested (or optional) data transmission schedule. In addition, a storage medium may be provided that includes stored instructions, when executed by a controller or processor that may result in the controller 1104 performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving, at a first wireless station in a wireless network, a first data transmission schedule from a second wireless station;
attempting, by the first wireless station, to transmit data according to the first data transmission schedule;
transmitting a request for a data transmission schedule change to the second wireless station;
receiving, at the first wireless station and in response to the transmitting the request, a second data transmission schedule from the second wireless station.

2. The method of claim 1 wherein the first station is operating in either a non power-save delivery mode or an unscheduled power-save delivery mode, the receiving a second data transmission schedule comprises receiving at the first wireless station a second data transmission schedule from the second wireless station, the first and second data transmission schedules being suggested and optional data transmission schedules for the second station.

3. The method of claim 1 wherein the first wireless station is operating in a scheduled power-save delivery mode, the receiving a second data transmission schedule comprises receiving, at the first wireless station and in response to the transmitting the request, a second data transmission schedule from the second wireless station, the first wireless station transmitting and receiving data according to the received data transmission schedules.

4. The method of claim 1 and further comprising attempting, by the first wireless station, to transmit data according to the second data transmission schedule.

5. The method of claim 1 wherein the receiving a first data transmission schedule comprises:
transmitting an add traffic stream request to the second wireless station;
receiving, at the first wireless station, the first data transmission schedule via an add traffic stream response from the second wireless station.

6. The method of claim 1 wherein the transmitting a request for a data transmission schedule change comprises transmitting an add traffic stream request to the second wireless station, the add traffic stream request including a traffic specification element with a field set to indicate a request for a new or different data transmission schedule.

7. The method of claim 1 wherein the transmitting a request for a data transmission schedule change comprises transmitting an add traffic stream request to the second wireless station, the add traffic stream request including at least one of:
a requested service start time indicating a requested time when a first service period for data transmission would start; and
a requested service interval indicating a requested time or requested range of times between two successive service periods for data transmission.

8. The method of claim 1 wherein the attempting to transmit comprises attempting to obtain a transmission opportunity (TXOP) via a contention-based channel access mechanism during a time indicated by the first data transmission schedule.

9. The method of claim 1 wherein the transmitting a request for a data transmission schedule change comprises:
detecting a data collision or other transmission difficulty during the attempting to transmit data; and
transmitting a request for a new data transmission schedule to the second wireless station.

10. The method of claim 1 wherein the receiving a first data transmission schedule comprises receiving a first data transmission schedule from the second wireless station, and wherein receiving a second data transmission schedule comprises receiving, in response to the sending the request, a second data transmission schedule from the second wireless station, wherein each of the first data transmission schedule and the second data transmission schedule includes at least one of:
a service start time indicating an anticipated time when a first service period starts for data transmission; and
a service interval indicating a time between two successive service periods for data transmission.

11. The method of claim 1 wherein the transmitting a request for a data transmission schedule change comprises transmitting a request for a data transmission schedule change to the second wireless station via an intermediate station;
wherein said receiving a second data transmission schedule comprises receiving, at the first wireless station via the intermediate station and in response to the transmitting the request, a second data transmission schedule from the second wireless station.

12. A method comprising:
transmitting a request for a suggested data transmission schedule from a first wireless station in a wireless network to a second wireless station; and
receiving, at the first wireless station and in response to the transmitting the request, a suggested and optional data transmission schedule from the second wireless station.

13. The method of claim 12 wherein the transmitting comprises transmitting a request for a suggested data transmission schedule from a first wireless station in a wireless network to a second wireless station, the first wireless station operating in either a non power-save delivery mode or an unscheduled power-save delivery mode.

14. The method of claim 12 and further comprising the first station obtaining a transmission opportunity via a contention-based channel access mechanism according to the received data transmission schedule.

15. The method of claim 12 wherein the transmitting a request for a suggested data transmission schedule comprises transmitting an add traffic stream request to the second wireless station, the add traffic stream request including a field indicating a request for a schedule or schedule change.

16. The method of claim 12 and further comprising the first station providing an indication to the second station that interference was detected and the approximate time of the interference.

17. A method comprising:
receiving at a first station a measurement report including information relating to a performance or operation of a second wireless station;
transmitting a data transmission schedule to the second wireless station.

18. The method of claim 17 wherein the receiving comprises receiving, at a first station from the second station, a quality of service (QoS) related report including one or more measured QoS parameters for the second wireless station.

19. The method of claim 17 wherein the transmitting comprises at least one of:
transmitting a suggested and optional data transmission schedule to the second station, the second station operating in either a non power-save delivery mode or an unscheduled power-save delivery mode;
transmitting a new or changed data transmission schedule to the second wireless station, the second station operating in a power-save delivery mode and transmitting and receiving data according to the new data transmission schedule.

20. The method of claim 17 wherein the receiving comprises receiving a triggered quality of service (QoS) related report including one or more measured QoS parameters for the second station, the triggered QoS related report being transmitted from the second wireless station to the first wireless station when a QoS related threshold is met.

21. An apparatus provided in a station for wireless communication, the apparatus comprising:
a controller;
a memory coupled to the controller; and
a wireless transceiver coupled to the controller; and
the apparatus adapted to:
transmit a request for a suggested data transmission schedule to a first wireless station; and
receive, in response to the transmitting the request, a suggested and optional data transmission schedule from the first wireless station.

22. The apparatus of claim 21 wherein the apparatus comprises a wireless station operating in either a non power-save delivery mode or an unscheduled power-save delivery mode.

23. An apparatus comprising:
a computing device; and
instructions that when executed on the computing device cause the computing device to:
receive at a first station a measurement report including information relating to a performance or operation of a second wireless station; and
transmit a data transmission schedule to the second wireless station in response to receiving the measurement report.

24. The apparatus of claim 23 wherein said instructions, when executed on the computing device, cause the computing device to:
determine if the measurement report indicates the performance or operation of the second wireless station meets a criteria; and
transmit a data transmission schedule to the second wireless station if, based on the measurement report, the performance or operation of the second wireless station meets the criteria.

25. An article comprising:
a storage medium;
said storage medium including stored thereon instructions that, when executed by a processor, result in:
transmitting a request for a suggested or changed data transmission schedule from a first wireless station in a wireless network to a second wireless station; and
receiving, at the first wireless station and in response to the transmitting the request, the requested data transmission schedule from the second wireless station.

26. The article of claim 25 wherein the instructions resulting in receiving comprises receiving at the first wireless station a suggested and optional data transmission schedule for the second station, the first station operating in either a non power-save delivery mode or an unscheduled power-save delivery mode.

27. An article comprising:
a storage medium;
said storage medium including stored thereon instructions that, when executed by a processor, result in:
receiving a request for a suggested or changed data transmission schedule at a first wireless station from a second wireless station in a wireless network; and
transmitting, from the first wireless station and in response to the receiving the request, the requested data transmission schedule to the second wireless station.

28. The article of claim 27 wherein the instructions resulting in receiving comprises receiving at the first wireless station a request for a suggested and optional data transmission schedule for the second station, wherein second station is operating in either a non power-save delivery mode or an unscheduled power-save delivery mode.

29. An apparatus comprising:
a computing device; and
instructions that when executed on the computing device cause the computing device to:
receive a request for a suggested or changed data transmission schedule at a first wireless station from a second wireless station in a wireless network; and
transmit, from the first wireless station and in response to the receiving the request, the requested data transmission schedule to the second wireless station.

30. The apparatus of claim 29 wherein said instructions that cause the computing device to receive comprises:
instructions that cause the computing device to receive at the first wireless station a request for a suggested and optional data transmission schedule for the second station, wherein second station is operating in either a non power-save delivery mode or an unscheduled power-save delivery mode.
